(19) United States
(12) Patent Application Publication
(10) Pub. No.: US 2006/0191284 A1
(43) Pub. Date: Aug. 31, 2006

(54) Beverage cooler adapter

(76) Inventor: James M. Fuller, Euless, TX (US)

Correspondence Address: Michael A. O'Neil;Michael A. O'Neil, P.C., Suite 820, 5949 Sherry Lane, Dallas, TX, 75225, US

(21) Appl. No.: 11/361,951

(22) Filed: Feb. 24, 2006

Related U.S. Application Data
(60) Provisional application No. 60/657,215, filed on Feb. 28, 2005.

(51) Int. Cl. B67D 5/62; F25D 3/08; F25D 13/00; F25D 3/02

(52) U.S. Cl. 62/389; 62/457.4; 62/458; 62/463; 222/146.6

(57) ABSTRACT

A beverage cooler adapter secures into the bottom of a portable cooler for facilitating use of the cooler in conjunction with volume beverage containers. The beverage adapter facilitates storing and dispensing cooled beverages in a manner that prevents contaminants from entering the beverage before being dispensed from the cooler.

### CROSS-REFERENCE TO RELATED APPLICATION

This application claims priority of provisional Application Ser. No. 60/657,215 filed Feb. 28, 2005, the entire content of which is incorporated herein by reference.

### TECHNICAL FIELD

This invention relates generally to beverage coolers, and more particularly to a beverage cooler adapter useful in conjunction with traditional beverage coolers for adapting the cooler to receive beverage containers for dispensing of the beverages contained therein in a substantially sanitary condition.

### BACKGROUND AND SUMMARY OF THE INVENTION

Beverage coolers such as the 400 Series Industrial Strength Water Coolers, two to ten gallon coolers sold by Igloo® have long been used to provide large volumes of hot and cold beverages at construction and industrial work sites, at recreational and/or social events, on the sidelines for sports teams, etc. As is well known, water is required to be supplied at industrial work sites, specifically OSHA requires “[a]n adequate supply of potable water shall be provided in all places of employment” and that “[p]ortable containers used to dispense drinking water shall be capable of being tightly closed, and equipped with a tap.”

Traditionally a beverage is poured into the cooler and ice is added thereto. There are many opportunities for contamination of the beverage during the transfer of the beverage into the cooler and the loading of the ice into the cooler. For example, at industrial and construction work sites the water is often poured into portable containers from the same hose used on the job site, often found lying in mud, etc. In addition to a dirty hose, the ice may likely be loaded into the container by a shovel used on the job site. At recreational and/or social events, water, tea, and other beverages served in mass quantity may be loaded into a cooler by kitchen personnel who should be following food safety guidelines, but often someone planning or coordinating the event will be preparing the cooler and more than likely are not familiar with or following food safety guidelines.

In addition to contamination of the beverage contained within the cooler, having the beverage and ice mixed together results in watering down of the beverage once the ice begins to melt. Beverages can be served from volume containers such as those distributed by Ozarka®, Sparkletts®, and the like, but these jugs require special cooler stands to chill and dispense the beverage electricity is necessary for cooling. There are currently no portable coolers available to receive and chill large volume containers of other beverages, such as Gatorade®, tea, colas, and the like.

The present invention comprises a beverage cooler adapter for use in conjunction with traditional beverage coolers which overcomes the foregoing and other difficulties which have long sense characterized the prior art. In accordance with the broader aspects of the invention, a beverage cooler adapter is secured in the bottom of an existing cooler for receiving volume containers of beverages such as water, Gatorade®, colas, and the like.

In accordance with more specific aspects of the invention the beverage cooler adapter comprises a conduit extending to the proximal end of the of the dispensing tap of the cooler. Volume containers such as water jugs, multi-gallon containers of Gatorade®, colas, and the like are inverted and the mouth of the container is placed in a receiving orifice on the top surface of the adapter. An o-ring is secured around the mouth of the jug for stabilizing the jug in the receiving orifice. In addition to stabilizing the beverage container, the o-ring also seals the entry to the orifice to prevent foreign items or contaminates from mixing with the beverage and for preventing leakage. A removable piercing tip is provided within the adapter for use with beverage containers having a thin diaphragm over the mouth of the container.

Once the beverage container is secured in the receiving orifice of the adapter, ice may be added around the inserted container without concern of contaminating or watering-down the contained beverage. The result is the ability to dispense a sanitary, cooled beverage from a portable cooler which is economical to purchase and use and which facilitates compliance with industrial and health safety regulations.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view of a beverage cooler adapter comprising a first embodiment of the present invention installed into a traditional five-gallon cooler;

FIG. 2 is an exploded perspective view of the beverage cooler adapter and cooler shown in FIG. 1;

FIG. 3 is a perspective view of a beverage cooler adapter comprising a second embodiment of the present invention;

FIG. 4 is a sectional view of the beverage cooler adapter shown in FIG. 3;

FIG. 5A is an environmental view illustrating an initial step in the utilization of the beverage cooler adapter shown in FIG. 1;

FIG. 5B is an environmental view illustrating a later step in the utilization of the beverage cooler adapter shown in FIG. 1;

FIG. 5C is an environmental view illustrating a somewhat later step in the utilization of the beverage cooler adapter shown in FIG. 1;

FIG. 5D is an environmental view illustrating a still later step in the utilization of the beverage cooler adapter shown in FIG. 1;

FIG. 6 is a perspective view illustrating the beverage cooler adapter of the present invention being utilized with a different type of cooler;

FIG. 7 is an exploded view of a beverage cooler adapter comprising a third embodiment of the invention; and

FIG. 8 is sectional view of the beverage cooler adapter shown in FIG. 7.

### DETAILED DESCRIPTION

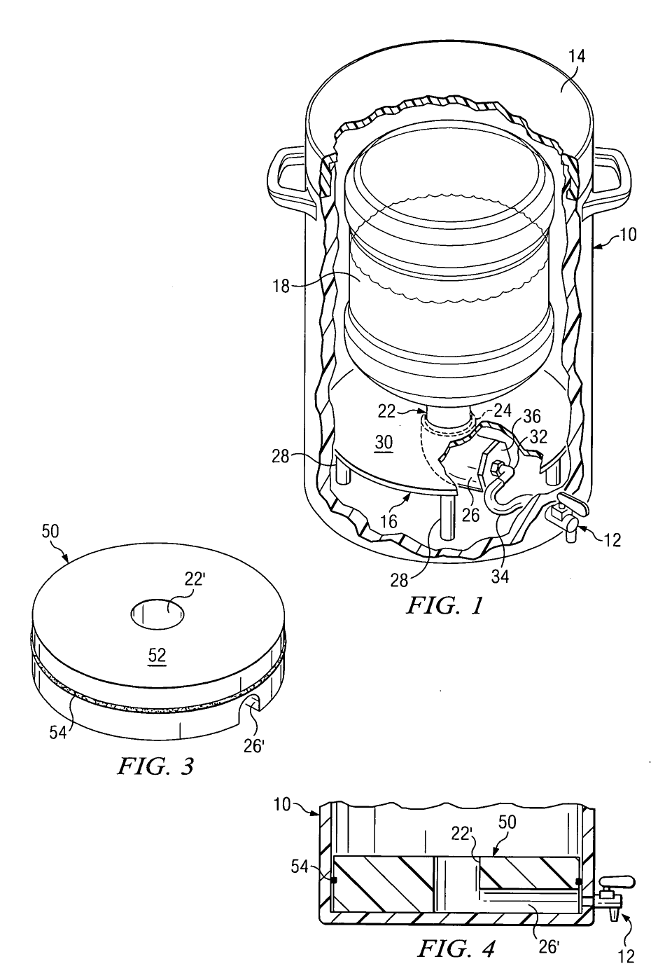

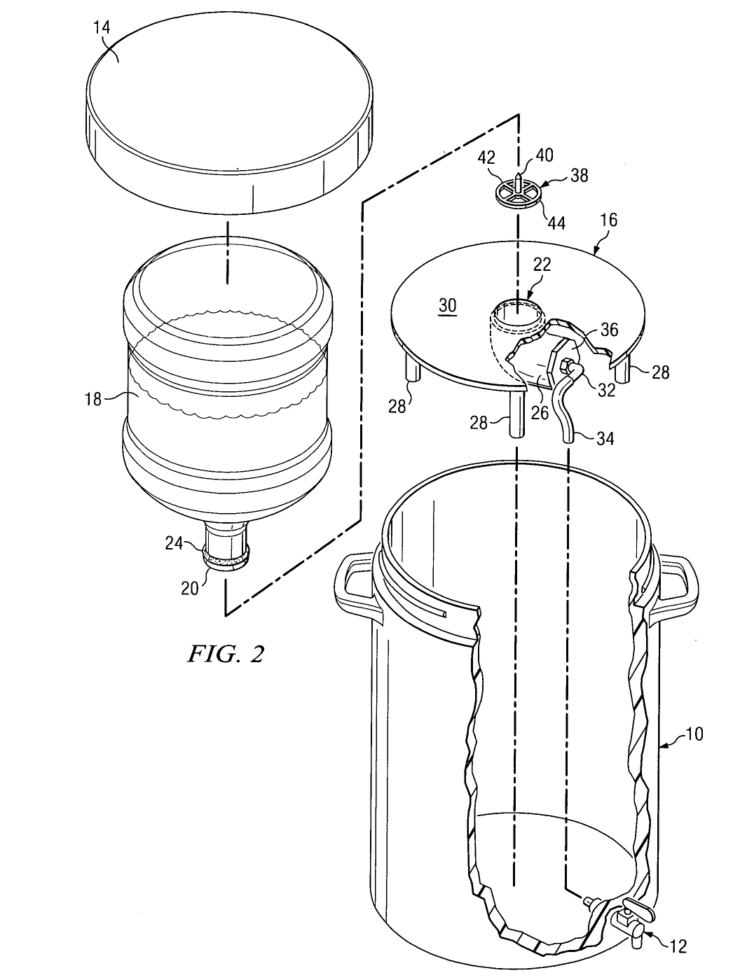

Referring now to the Drawings, and particularly to FIGS. 1 and 2 thereof, there is shown a commercially available beverage cooler 10 having a dispenser 12 and a lid 14 utilizing a beverage cooler adapter 16 comprising a first embodiment of the invention. A beverage container 18 is inverted and the mouth 20 of the container 18 is received into a receiving orifice 22 in the cooler adapter 16. An o-ring 24 secured around the mouth 20 of the container 18 secures the container 18 in a stable position. A conduit 26 conveys the liquid beverage to the dispenser 12 located near the bottom of the cooler 10. The cooler adapter 16 is positioned in the cooler 10 and is supported by legs 28 which are fastened beneath a support member 30 comprising the cooler adapter 16.

The orifice 22 is located at or near the center of the support member 30 having the conduit 26 beginning directly therebelow. The conduit 26 conveys the liquid beverage from the orifice 22 to the dispenser 12. The conduit 26 connects to the dispenser 12 by a connector 32 and a hose 34. The connector 32 is threadedly secured to a cap 36 on the end of the conduit 26. The hose 34 is connected to the connector 32 to complete the conveyance of liquid from the conduit 26 to the dispenser 12. The support member 30, conduit 26, cap 36, and connector 32 may be constructed of polyvinyl chloride (PVC) pipe, or other similar materials known to those skilled in the art of manufacturing potable water supply systems. The hose 34 may be constructed from rubber or other suitable flexible materials known to those skilled in the art of manufacturing potable water supply systems.

A removable piercing tip insert 40 may be used in conjunction with the cooler adapter of the present invention when the beverage container 18 has a diaphragm over the mouth 20 of the container 18. The insert 40 includes a piercing tip 42 which is used to puncture the diaphragm thereby allowing the beverage to flow from the container 18. The piercing tip 42 is mounted on a perforated disc 44 which is received in the orifice 22 of the cooler adapter 16. An o-ring 46 is secured around the disk to hold the piercing tip insert 40 in a stable position inside the orifice 22.

Referring to FIGS. 3 and 4 there is shown a cooler adapter 50 comprising a second embodiment of the present invention. Many of the components of the cooler adapter 50 are substantially identical in construction and function to components of the cooler adapter 16 illustrated in FIGS. 1 and 2 described hereinabove in conjunction therewith. Such identical component parts are designated in FIGS. 3 and 4 with the same reference numerals utilized above in the description of the cooler adapter 16, but are differentiated therefrom by means of a prime (′) designation.

The cooler adapter 50 differs from the cooler adapter 16 of FIGS. 1 and 2 in that the cooler adapter 50 is not supported by legs fastened beneath a support member, but instead comprises a single support member 52 which rests directly on the bottom of the cooler 10. Inside the support member 52 a conduit 26′ connects the orifice 22′ directly to the cooler dispenser 12 without the need for any additional connectors or a hose. An o-ring 54 is mounted around the circumference of the support member 52 to secure the adapter 50 in a stable position inside the cooler 10 and to prevent leakage.

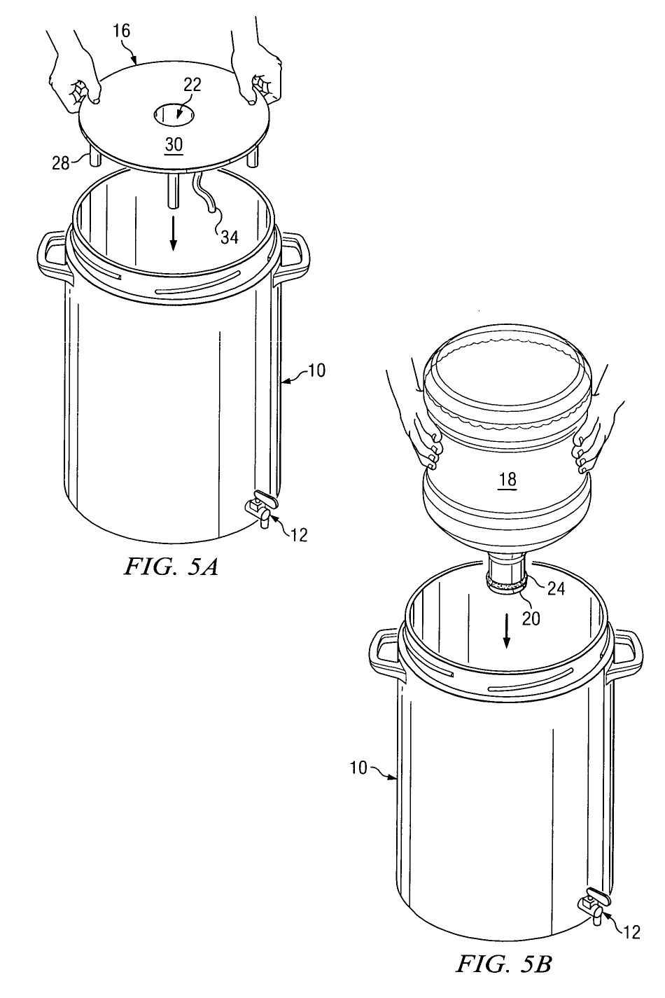

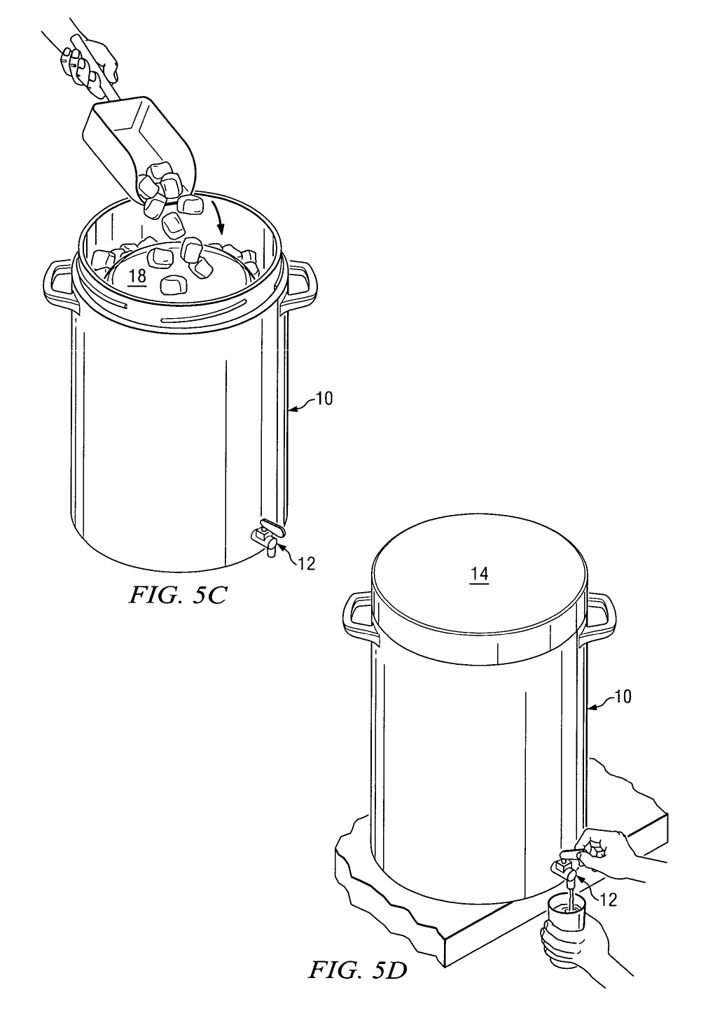

FIG. 5A illustrates the initial step in the utilization of the cooler adapter 16. The cooler adapter 16 is placed into the bottom of the cooler 10 and the hose 34 is connected to the dispenser 12. FIG. 5B illustrates a further step in the utilization of the cooler adapter 16. The o-ring 24 is secured around the mouth 20 of the container 18 after which the container 18 is inverted and placed into the cooler adapter 16 inside the cooler 10. Alternatively, the container 18 may remain in an upright condition to receive the adapter 16 thereon until the o-ring 24 seats. The container 18 having the adapter 16 received thereon is then placed into the cooler 10. As best shown in FIG. 5C, once the container 18 is secured into the cooler adapter 16, ice may be added into the cooler 10 around the container 18. The lid 14 of the cooler 10 is then secured and the beverage may be dispensed as shown in FIG. 5D.

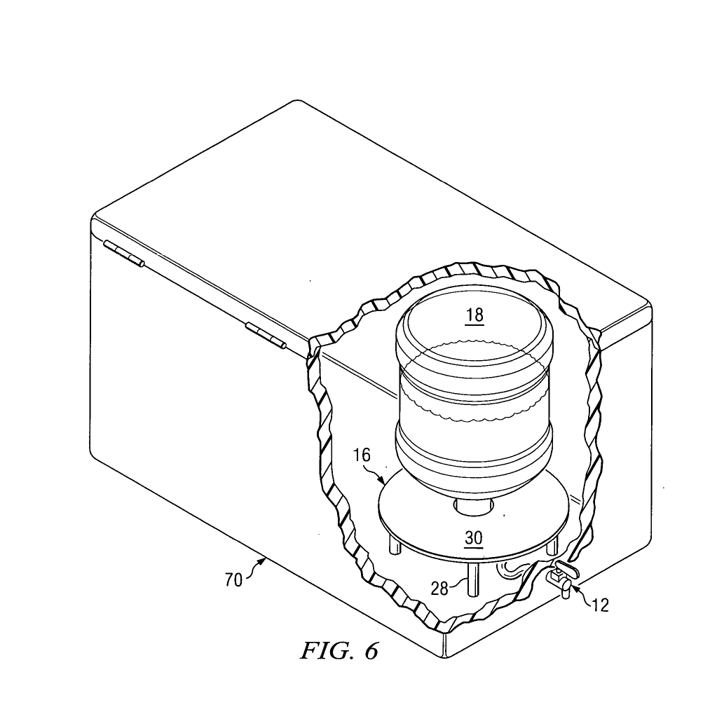

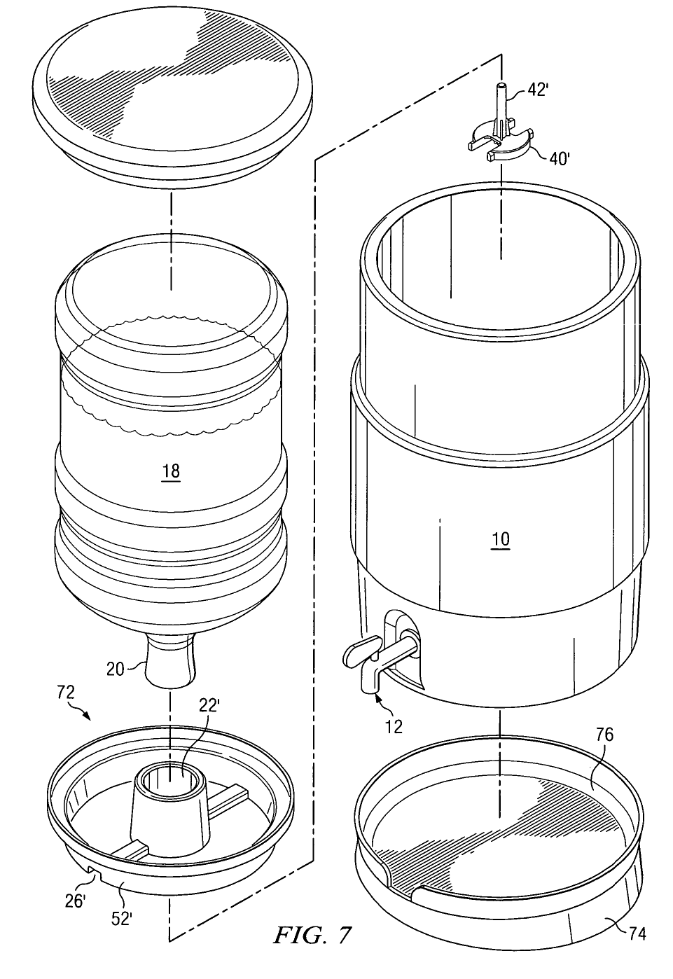

FIG. 6 illustrates the cooler adapter 16 being used in conjunction with a rectangular cooler 70. The cooler adapter 16 is inserted into the cooler 70 and connected with the dispenser 12 in the same manner as illustrated in FIGS. 1 through 5D and described hereinabove in conjunction therewith; however, additional fastening devices may be used to secure the cooler adapter 16 in a stable position inside the cooler 70.

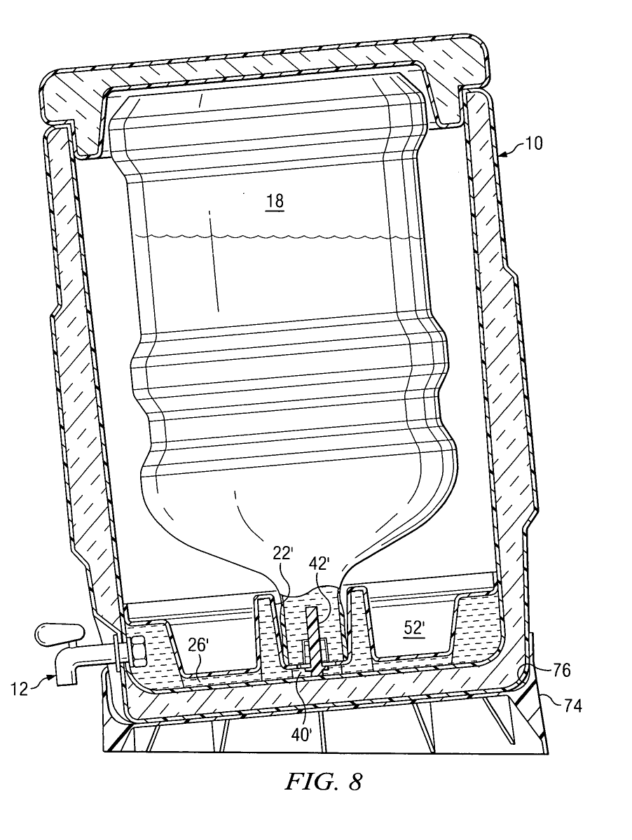

FIGS. 7 and 8 illustrates a cooler adapter 72 comprising a third embodiment of the invention. Many of the components of this embodiment are substantially identical in construction and function to components of the embodiments illustrated in FIGS. 1, 2, 3, and 4 described hereinabove in conjunction therewith. Such identical component parts are designated in FIGS. 7 and 8 with the same reference numerals utilized above, but are differentiated therefrom by means of a prime (′) designation.

The cooler adapter 72 is similar to the cooler adapter 50 in that it comprises a single support member 52′ having an orifice 22′ for receiving the mouth 20 of the beverage container 18 as well as a conduit 26′ that connects the orifice 22′ directly to the cooler dispenser 12 without the need for any additional connectors or a hose.

A removable piercing tip insert 40′ is used in conjunction with the cooler adapter 72 where the beverage container 18 has a diaphragm over the mouth 20 of the container 18. The insert 40′ includes a piercing tip 42′ which is used to puncture the diaphragm thereby allowing the beverage to flow from the container 18. The piercing tip insert 40′ fits securely within the orifice 22′.

In this embodiment the beverage cooler 10 is positioned on a foot piece 74 supporting a lip 76 at slight, predetermined angle from the horizontal plane to facilitate the flow of the beverage from the container 18.

The present invention has been illustrated in conjunction with the five-gallon cylindrical coolers of the type sold by Igloo® and smaller rectangular coolers, but the beverage cooler adapter of the present invention may be configured to be used in the majority of coolers having a dispensing tap thereon.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A beverage cooler adapter for use in conjunction with a portable cooler of the type having a dispenser near the bottom thereof and a beverage container having a mouth, the improvement comprising:
a support member having a receiving orifice for receiving the mouth of the beverage container
the mouth of the beverage container being positioned downwardly to facilitate liquid flow from the beverage container;
means for positioning the support member within the portable cooler near the bottom thereof;
means for securing the mouth of the beverage container inside the receiving orifice; and
a conduit below the receiving orifice of the support member for conveying liquids between the receiving orifice and the dispenser.

2. The beverage cooler adapter according to claim 1 wherein the means for securing the beverage container inside the receiving orifice of the support member is an o-ring secured about the mouth of the beverage container.

3. The beverage cooler adapter according to claim 1 wherein the conduit connects directly to the dispenser.

4. The beverage cooler adapter according to claim 1 wherein the conduit connects to the dispenser via an adapter threadedly secured into a cap over the end of the conduit and a hose extending between the connector and the dispenser.

5. The beverage cooler adapter according to claim 1 further comprising:
a diaphragm covering the mouth of the beverage container;
a piercing tip removably positioned within the receiving orifice of the support member so as to puncture the diaphragm covering the mouth of the beverage container and facilitate liquid flow from the beverage container.

6. The beverage cooler adapter according to claim 1 wherein the means for positioning the support member within the portable cooler is legs mounted below the support member for supporting the beverage cooler adapter inside the cooler.

7. The beverage cooler adapter according to claim 1 further comprising an o-ring secured around the circumference of the support member for securing the support member in a stable position inside the cooler.

8. A beverage cooler adapter for use in conjunction with a portable cooler of the type having a dispenser near the bottom thereof and a beverage container having a mouth, the improvement comprising:
a support member having a receiving orifice for receiving the mouth of the beverage container
the mouth of the beverage container being positioned downwardly to facilitate liquid flow from the beverage container;
a diaphragm covering the mouth of the beverage container;
means for positioning the support member within the portable cooler near the bottom thereof;
means for securing the mouth of the beverage container inside the receiving orifice of the support member;
a piercing tip removably positioned within the receiving orifice of the support member so as to puncture the diaphragm covering the mouth of the beverage container when the mouth of the beverage container is secured inside the receiving orifice of the support member;
a conduit below the receiving orifice of the support member for conveying liquids between the receiving orifice and the dispenser; and
a foot piece for supporting the portable cooler at an angle to further facilitate liquid flow from the beverage container.
